(19) United States
(12) Patent Application Publication
(10) Pub. No.: US 2016/0032532 A1
(43) Pub. Date: Feb. 4, 2016

(54) COARSE GROUND CALCIUM CARBONATE WITH HIGH STEEPNESS

(71) Applicant: IMERYS PIGMENTS, INC., Roswell, GA (US)

(72) Inventors: PHIL JONES, WOODSTOCK, GA (US); MIKEL DEAN SMITH, TENNILLE, GA (US); ROBERT PRUETT, MILLEDGEVILLE, GA (US)

(21) Appl. No.: 14/777,150

(22) PCT Filed: Mar. 11, 2014
(86) PCT No.: PCT/US2014/023319

§ 371 Date: Sep. 15, 2015

Related U.S. Application Data
(60) Provisional application No. 61/786,861, filed on Mar. 15, 2013.

(51) Int. Cl. D21H 19/14; C01F 11/18; C08K 3/34; D21H 19/12; C09D 1/00; C08K 3/26

(52) U.S. Cl. CPC D21H 19/14; C09D 1/00; C08K 3/26; C08K 3/346; D21H 19/12; C01F 11/18; C08K 2003/265; C01P 2004/61

(57) ABSTRACT

A composition including ground calcium carbonate may have a coarse particle size and high steepness factor. Some compositions may include ground calcium carbonate and an additive, such as kaolin. A coating including ground calcium carbonate may have a course particle size and high steepness factor, and a carrier suspending the ground calcium carbonate. The ground calcium carbonate may have a mean particle size (d₅₀) greater than about 2.4 μm. The ground calcium carbonate may also have a steepness factor greater than about 30. Also described are products including a substrate and a coating applied to the substrate, where the coating includes ground calcium carbonate having a coarse particle size and high steepness factor.

### CLAIM OF PRIORITY

This PCT International Application claims the benefit of priority of U.S. Provisional Application No. 61/786,861, filed Mar. 15, 2013, the subject matter of which is incorporated herein by reference in its entirety.

### FIELD OF THE DESCRIPTION

This disclosure relates to compositions including ground calcium carbonate with a relatively coarse particle size and a relatively high steepness factor.

### BACKGROUND

Paperboard is used in various packaging applications. For example, in some liquid packaging paperboard is used for packaging beverage cartons, containers, boxes, and other packaging materials. Customers and manufacturers often prefer paperboard having a generally smooth surface with few imperfections to facilitate the printing of high quality text and graphics on the container, thereby increasing the visual appeal of products packaged in paperboard.

Paperboard smoothness has been achieved by a wet stack calendering process in which the paperboard is rewetted and passed through a calendering device having two or more hard rolls. The wet stack calendering process results in reduced board thickness and bulk, but also results in reduced stiffness. Stiffness may be an important characteristic for many paperboard applications, such as liquid packaging paperboard. However, preparing a smooth yet stiff paperboard using the conventional wet stack calendering process requires increasing the basis weight of the paperboard, thereby substantially increasing the raw material cost.

Alternatively, manufacturers have attempted to smooth the surface of paperboard by coating the entire surface of the paperboard with a basecoat including various pigments, such as clay, calcium carbonate, TiO₂, and the like. Coatings applied to paperboard products generally contain relatively fine particles (e.g., pigments) to improve the smoothness of the surface after coating. For example, coatings containing large quantities of relatively fine pigment particles may be applied to the surface of paperboard to provide a smoother surface without the need for wet stack calendering, thereby maintaining bulk. However, the use of relatively high quantities of fine pigments may substantially increase the cost of the coating. In addition, large particles not removed during processing may also create blemishes on the surface because the large particles may protrude from the surface. This may lead to rough protrusions in an otherwise smooth coating surface.

Conventional compositions may also have several types of particles or additives. To enhance the smoothness of the resulting base coat, additives may be included in the coating or composition. However, the use of additives may increase processing time and processing difficulty of a composition. Additives may also increase the manufacturing cost of the composition.

Coated paperboards are also widely used in the packaging industry. However, paper and paperboard products may be very sensitive to moisture and moisture vapors. Barrier properties of a coating applied to paperboard products may provide a barrier against moisture, oil, water vapors, or gases, and may also enhance the physical and optical properties of the substrate. However, the manufacturing process of the substrates may also result in substantial deformation or stress on the coatings. For example, paper and paperboard substrates used in the printing and converting industries may be subjected to a variety of manufacturing operations, such as, for example, printing, cutting, creasing, folding, and/or gluing.

These manufacturing operations are often important processes in the converting industry. However, such manufacturing operations may result in applying significant strains to the paper or paperboard substrates. Such strains challenge the mechanical strength of the substrates as well as any coating layers present on the substrates. For example, rupture occurring at creased and folded edges of the paper and paperboard products may weaken barrier properties of the substrate or coating significantly and may diminish the overall aesthetic appeal of a packaging formed by the product. An inability to withstand these large strains may lead to rupture of folded edges, potentially resulting in large cracks and/or flaking-off of the coating layer.

Traditionally, coating layers with higher stiffness have been preferred, because higher stiffness coating layers may provide superior strength and/or reduction in the fiber usage for the substrate. However, stiffer coating layers may tend to increase the severity of cracking or flaking occurring at folded edges of paper or paperboards.

Accordingly, it may be desirable to provide a composition that provides a desired smoothness for high quality printing. It may also be desirable to provide a composition for use in a coating that maintains the desired smoothness when applied to a substrate, such as paperboard. It may be further desirable to provide coating compositions that exhibit improved resistance to cracking and/or flaking when the substrates coated with the coating composition are folded, creased, or otherwise deformed, thereby improving performance when the substrates undergo printing or converting operations. It may also be desired to provide a coating composition that results in a smooth surface, while reducing the tendency of the coating to crack or flake under mechanical strain.

### SUMMARY

In accordance with a first aspect, a composition includes ground calcium carbonate having a mean particle size (d₅₀) of at least about 2.4 μm and a steepness factor of at least about 30.

According to another aspect, a coating includes ground calcium carbonate having a d₅₀ of at least about 2.4 μm and a steepness factor of at least about 30. The coating also includes a carrier suspending the ground calcium carbonate. The ground calcium carbonate may be substantially non-aggregated in the carrier.

According to yet another aspect, a product includes a substrate and a coating applied to the substrate. The coating includes a ground calcium carbonate having a d₅₀ of at least about 2.4 μm and a steepness factor of at least about 30.

Particle sizes and other particle size properties referred to in the present disclosure, are measured using a Sedigraph 5100 instrument as supplied by Micromeritics Corporation. The size of a given particle is expressed in terms of the diameter of a sphere of equivalent diameter, which sediments through the suspension, i.e., an equivalent spherical diameter or esd. The mean particle size, or the d₅₀ value, is the value determined by the particle esd at which 50% by weight of the particles have an esd less than the d₅₀ value.

Particle size distribution (psd) of particulate material can also be characterized by a “steepness factor.” The steepness factor is derived from the slope of a psd curve, where the particle diameter is plotted on the x-axis against a cumulative mass percentage of particles on the y-axis. A wide particle distribution has a relatively lower steepness factor, whereas a narrow particle size distribution gives rise to a relatively higher steepness factor. In some aspects, the steepness factor may be calculated as a ratio of:

$$[ steepness factor ] = \frac{{d}_{30}}{{d}_{70}} \times 100$$

i.e., the ratio of the particle size at a cumulative mass of less than 30% of the particles (d₃₀), to the particle size at a cumulative mass of less than 70% of the particles (d₇₀), as determined by a Sedigraph 5100, multiplied by 100. As the d₃₀ and d₇₀ values approach each other, the steepness factor increases.

### DESCRIPTION OF EXEMPLARY EMBODIMENTS

Particle size data measured and reported herein, including in the examples disclosed herein, was taken in the above-described manner, with measurements made of the particulate material dispersed in water at the standard temperature under ambient air. Unless otherwise indicated, all percentages and amounts expressed herein are by weight.

According to some embodiments, a composition may include ground calcium carbonate having a d₅₀ of at least about 2.4 μm and a steepness factor of at least about 30. For example, according to some embodiments, the mean particle size (d₅₀) is greater than about 2.6 μm or greater than about 2.8 μm. According to some embodiments, the steepness factor (e.g., d₃₀/d₇₀×100) is greater than about 32, greater than about 34, greater than about 36, greater than about 40, or greater than about 43.

Some embodiments of the ground calcium carbonate may have the exemplary particle size distribution shown below in Table I:

TABLE I

| | Exemplary | |
|---|---|---|
| Sedigraph 5100 | Composition | |
| <10 μm (%) | 96-100 | wt. % |
| <5 μm (%) | 78-84 | wt. % |
| <2 μm (%) | 37-43 | wt. % |
| <1 μm (%) | 10-16 | wt. % |
| <0.5 μm (%) | 0-5 | wt. % |
| <0.25 μm (%) | 0-4 | wt. % |
| d₅₀ | >2.4 | μm |

| | |
|---|---|
| Steepness Factor | ≧30 |

As shown in Table I, greater than or equal to about 96% of the ground calcium carbonate may have a particle size less than about 10 μm. According to other embodiments, greater than or equal to about 88% of the ground calcium carbonate may have a particle size less than about 10 μm. For example, greater than or equal to about 90%, greater than about 92%, or greater than about 94% of the ground calcium carbonate may have a particle size less than about 10 μm.

According to some embodiments, the ground calcium carbonate may be ground using “attrition grinding.” Other grinding methods are also contemplated. According to some aspects, the calcium carbonate may be ground in a mill. Grinding can be achieved by various conventional grinding techniques, such as jaw crushing, roller milling, hammer milling, and ball milling.

According to some embodiments, the feed calcium carbonate (prior to milling or grinding) may include calcium carbonate obtained from sources chosen from calcite, limestone, chalk, marble, dolomite, etc. Ground calcium carbonate particles may be prepared by any known method, such as by conventional grinding techniques discussed above and optionally coupled with classifying techniques, e.g., jaw crushing followed by roller milling or hammer milling and air classifying.

According to some embodiments, a ground calcium carbonate may be classified to produce a narrower particle size distribution compared to the feed calcium carbonate, i.e., a higher steepness factor. Classification of the ground calcium carbonate includes processing the ground calcium carbonate to remove large particles. For example, classification may include passing the ground calcium carbonate through a hydrocyclone or centrifuge to separate coarse and fine particles. Other classification methods are contemplated, such as the use of centrifuge, hydraulic classifier, or elutriator.

According to some embodiments, during the classification process, the separated coarse particles (e.g., those larger than, for example, 5.0 μm or 10 μm) may be removed. The classification process may be repeated multiple times to further remove large particles not removed in the first classification. The multiple classifications may be used to either remove the same size of particle (e.g., 5.0 μm or larger) or to remove different sizes of particles (e.g., 5.0 μm or larger in the first classification and 4.0 μm or larger in the second classification). According to some embodiments, a calcium carbonate is triple-classified. In this disclosure, “triple classification” refers to classifying a ground calcium carbonate three times to remove coarse particles. The process of triple classification may contribute to a greater steepness factor by increasing the likelihood of removing the coarsest particles.

Although the classification process removes very coarse particles, it should be understood that the compositions of ground calcium carbonate disclosed herein may still maintain a relatively coarse particle size (e.g., d₅₀ greater than about 2.4 μm). However, by removing the very coarse particles (e.g., particles with an esd greater than about 10 μm), the steepness factor may be increased, and the resulting composition may provide a smoother coating because the distribution of particles is relatively narrower and the size of the particles is more uniform.

According to some embodiments, a product containing one of the ground calcium carbonates disclosed herein may be a product that is substantially free of dispersant, such as a polyacrylate. In some embodiments, a dispersant may be present in the product in an amount of up to about 5000 ppm.

According to some embodiments, the ground calcium carbonate particles are substantially non-aggregated, for example, most of the ground calcium carbonate particles exist as individual particles. For example, it is possible that at least about 90% or even at least about 95% by weight of the ground calcium carbonate is non-aggregated.

In some embodiments, compositions including the ground calcium carbonate are substantially free of additives. According to some embodiments, the compositions may include a carrier, but otherwise be substantially free of other additives.

According to some embodiments, compositions including ground calcium carbonate may include at least one additive, such as kaolin. It is understood that other additives may include coloring agents. It is contemplated that the additive may include at least one additional mineral as a filler or pigment. The at least one additional mineral may be a mineral that is different from the filler, such as calcined kaolin, hydrous kaolin, talc, mica, dolomite, silica, zeolite, gypsum, satin white, titania (TiO₂), and calcium sulphate.

According to some embodiments, the kaolin has a shape factor greater than about 40. For instance, the kaolin may have a shape factor greater than about 50, greater than about 60, greater than about 70, greater than about 80, greater than about 90, or greater than about 100. As used herein, “shape factor” is a measure of an average value (on a weight average basis) of the ratio of mean particle diameter to particle thickness for a population of particles of varying size and shape, as measured using the electrical conductivity method and apparatus described in, for example, U.S. Pat. No. 5,128,606, and using the equations derived in its specification. One method of determining the shape factor is to measure the electrical conductivity of a fully dispersed aqueous suspension of the ground calcium carbonate. According to one method, the ground calcium carbonate under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube. Using the difference between the two conductivity measurements, the shape factor of the particulate material under test may be determined.

The ground calcium carbonate may be suitable for use in a variety of non-aqueous based products, such as paints, architectural coatings, industrial coatings, adhesives, caulks, and sealants, for example, polysulphide sealing compositions. The calcium carbonate may be also used as fillers in rubber or plastics compositions. The disclosed calcium carbonate may be beneficial in non-aqueous based applications requiring a relatively high viscosity, and may allow a reduction in the amount of thickener needed to produce a product having the desired viscosity.

According to some embodiments, the disclosed ground calcium carbonate may also be suitable for use in coatings. For example, coatings may be applied to substrates, such as paper or paperboard, to improve the smoothness of the paperboard, to improve the barrier properties, or to enhance the visual appeal of graphics. The ground calcium carbonate may also reduce cost by providing the desired smoothness without requiring additional processing to obtain a fine particle size and/or without the additional expense of additives, such as kaolin.

When used in such coatings, it is understood that a composition including the ground calcium carbonate may optionally include at least one additional mineral as a filler or pigment. The additional mineral may be a mineral that is different from the ground calcium carbonate, such as calcined kaolin, platy kaolin, hydrous kaolin, talc, mica, dolomite, silica, zeolite, gypsum, satin white, titania (TiO₂), or calcium sulphate.

According to some embodiments, the coating composition may optionally contain one or more additional components. Such additional components, where present, are suitably selected from known additives for paper or paperboard coating compositions. Some additional components may provide more than one function in the coating composition. Examples of known classes of optional additives include, but are not limited to:
(a) One or more additional pigments: Although the compositions described herein can be used as sole pigments in the paper coating compositions, additional known pigments may be added. Examples of additional pigments include, for example, calcium sulphate, satin white, and so-called ‘plastic pigment.’ When a mixture of pigments is used, the total pigment solids content is preferably present in the composition in an amount of at least about 75% by weight of the total weight of the dry components of the coating composition.
(b) One or more binding or cobinding agents: One or more binding or cobinding agent may be added in an effective amount to promote binding or cobinding of at least one component of the composition Examples of binding or cobinding agents include, for example, latex, styrene acrylic copolymer latex, starch derivatives, sodium carboxymethyl cellulose, polyvinyl alcohol, and proteins. Examples of latex include, but are not limited to, a styrene-butadiene rubber latex; an acrylic polymer latex; and a polyvinyl acetate latex. According to some embodiments, a latex may, optionally, be carboxylated.
(c) One or more cross linkers: Cross linkers may be added in a sufficient amount to facilitate cross-linking of at least one component of the composition. The cross linker include, for example, up to about 5% by weight of glyoxals, melamine formaldehyde resins, ammonium zirconium carbonates, or other known cross-linkers.
(d) One or more dry or wet pick improvement additives: A dry or wet pick improvement additive may be included, for example, in levels up to about 2% by weight. Dry or wet pick improvement additives include, for example, melamine resin, polyethylene emulsions, urea formaldehyde, melamine formaldehyde, polyamide, calcium stearate, styrene maleic anhydride, and others.
(e) One or more dry or wet rub improvement and abrasion resistance additives: A dry or wet pick improvement and abrasion resistance additive may be included, for example, in levels up to about 2% by weight. Dry or wet pick improvement and abrasion resistance additives include, for example, glyoxal based resins, oxidised polyethylenes, melamine resins, urea formaldehyde, melamine formaldehyde, polyethylene wax, calcium stearate, and others.
(f) One or more water resistance additives: A water resistance additive may be included, for example, in levels up to about 2% by weight. Examples of water resistance additives include, for example, oxidised polyethylenes, ketone resin, anionic latex, polyurethane, SMA, glyoxal, melamine resin, urea formaldehyde, melamine formaldehyde, polyamide, glyoxals, stearates, and other materials commercially available for this function.
(g) One or more water retention aids: A water retention aid may be added, for example, in levels up to about 2% by weight. Examples of water retention aids include, for example, sodium carboxymethyl cellulose, hydroxyethyl cellulose, PVOH (polyvinyl alcohol), starches, proteins, polyacrylates, gums, alginates, polyacrylamide bentonite, and other commercially available products sold for such applications.
(h) One or more viscosity modifiers and/or thickeners: Viscosity modifiers and/or thickeners may also be added, for example, in levels up to about 2% by weight. Examples of viscosity modifiers and/or thickeners include, for example, acrylic associative thickeners, alkali-swellable acrylic thickeners, polyacrylates, emulsion copolymers, dicyanamide, triols, polyoxyethylene ether, urea, sulphated castor oil, polyvinyl pyrrolidone, CMC (carboxymethyl celluloses, for example sodium carboxymethyl cellulose), sodium alginate, xanthan gum, sodium silicate, acrylic acid copolymers, HMC (hydroxymethyl celluloses), HEC (hydroxyethyl celluloses), and others.
(i) One or more lubricity/calendering aids: Lubricity or calendering aids may be added, for example, in levels up to about 2% by weight. Examples of lubricity/calendering aids include, for example, calcium stearate, ammonium stearate, zinc stearate, wax emulsions, waxes, alkyl ketene dimer, and glycols. Examples of lubricity/calendering aids also include gloss-ink hold-out additives, which may be added, for example, in levels up to about 2% by weight. Examples of gloss-ink hold-out additives include, for example, oxidised polyethylenes, polyethylene emulsions, waxes, casein, guar gum, CMC, HMC, calcium stearate, ammonium stearate, sodium alginate, and others.
(j) One or more dispersants: Dispersants may be added in a sufficient amount to prevent or effectively restrict flocculation or agglomeration of the ground calcium carbonate particles to a desired extent, according to normal processing requirements. The dispersant may be present, for example, in levels up to about 1% by weight. Examples of dispersants include, for example, polyelectrolytes such as polyacrylates and copolymers containing polyacrylate species, especially polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine, and other reagents commonly used for this function. The dispersant may be selected from conventional dispersant materials commonly used in the processing and grinding of inorganic particulate materials, such as calcium carbonate. Such dispersants will be recognized by those skilled in this art. Dispersants are generally water-soluble salts capable of supplying anionic species which in their effective amounts can adsorb on the surface of the inorganic particles and thereby inhibit aggregation of the particles. The unsolvated salts suitably include alkali metal cations, such as sodium. Solvation may in some cases be assisted by making the aqueous suspension slightly alkaline. Examples of suitable dispersants also include water soluble condensed phosphates, for example, polymetaphosphate salts [general form of the sodium salts: (NaPO₃)ₓ], such as tetrasodium metaphosphate or so-called “sodium hexametaphosphate” (Graham's salt); water-soluble salts of polysilicic acids; polyelectrolytes; salts of homopolymers or copolymers of acrylic acid or methacrylic acid; or salts of polymers of other derivatives of acrylic acid, suitably having a weight average molecular mass of less than about 20,000. Sodium hexametaphosphate and sodium polyacrylate, the latter suitably having a weight average molecular mass in the range of about 1,500 to about 10,000, are preferred.
(k) One or more antifoamers and defoamers: Antifoamers or defoamers may be added, for example, in levels up to about 1% by weight. Examples of antifoamers or defoamers include, for example, blends of surfactants, tributyl phosphate, fatty polyoxyethylene esters plus fatty alcohols, fatty acid soaps, silicone emulsions and other silicone containing compositions, waxes, inorganic particulates in mineral oil, blends of emulsified hydrocarbons, and other compounds commercially available to carry out this function.
(l) One or more optical brightening agents (OBA) and/or fluorescent whitening agents (FWA): OBA and/or FWA may be added, for example, in levels up to about 1% by weight. Examples of OBA or FWA include, for example, stilbene derivatives and others known compounds.
(m) One or more dyes: At least one additional dye may be added, for example, in levels up to about 0.5% by weight.
(n) One or more biocides/spoilage control agents: Biocides or spoilage control agents may be added, for example, in levels up to about 1% by weight. A biocide may be oxidizing or non-oxidizing. Oxidizing biocides include, for example, chlorine gas, chlorine dioxide gas, sodium hypochlorite, sodium hypobromite, hydrogen, peroxide, peracetic oxide, and ammonium bromide/sodium hypochlorite. Non-oxidizing biocides include, for example, GLUT (Glutaraldehyde, CAS No 90045-36-6), ISO (CIT/MIT) (Isothiazolinone, CAS No 55956-84-9 & 96118-96-6), ISO (BIT/MIT) (Isothiazolinone), ISO (BIT) (Isothiazolinone, CAS No 2634-33-5), DBNPA, BNPD (Bronopol), NaOPP, CARBAMATE, THIONE (Dazomet), EDDM—dimethanol (O-formal), HT—Triazine (N-formal), THPS—tetrakis (O-formal), TMAD—diurea (N-formal), metaborate, sodium dodecylbenene sulphonate, thiocyanate, organosulphur, and sodium benzoate. Other compounds are commercially available for this function, for example, the range of biocide polymers sold by Nalco.
(o) One or more levelling and evening aids: Levelling or evening aids may be added, for example, in levels up to about 2% by weight. Levelling aids or evening aids include, for example, non-ionic polyol, polyethylene emulsions, fatty acid, esters and alcohol derivatives, alcohol/ethylene oxide, calcium stearate, and other compounds commercially available for this function.
(p) One or more grease and oil resistance additives: Grease or oil resistance additive may be added, for example, in levels up to about 2% by weight. Examples of grease or oil resistance additives include, for example, oxidised polyethylenes, latex, SMA (styrene maleic anhydride), polyamide, waxes, alginate, protein, CMC, and HMC.

Any of the above additives and additive types may be used alone or in admixture with each other and with other additives, if desired.

For all of the above additives, the percentage weights listed are based on the dry weight of ground calcium carbonate (100%) present in the composition. Where the additive is present in a minimum amount, the minimum amount may be about 0.01% by weight based on the dry weight of ground calcium carbonate.

In certain embodiments, coating of the coating composition is carried out using standard techniques which are well known. The coating process may also involve calendering or supercalendering the coated product.

Methods of coating paper and other sheet materials, and apparatuses for performing the methods, are widely published and well known. Such known methods and apparatus may conveniently be used for preparing coated paper or paperboard. For example, a review of some methods is published in Pulp and Paper International, May 1994, page 18 et seq. Sheets may be coated “on-machine,” i.e., on the sheet forming machine, or “off-machine” on a coater or coating machine. Use of high solids compositions is desirable in the coating method because it leaves less water to subsequently evaporate. However, as is well known in the art, the solids level should not be so high that high viscosity and leveling problems are introduced.

The methods of coating may be performed using an apparatus comprising (i) an application for applying the coating composition to the material to be coated and (ii) a metering device for ensuring that a correct level of coating composition is applied. When an excess of coating composition is applied to the applicator, the metering device may be downstream of the applicator. Alternatively, the correct amount of coating composition may be applied to the applicator by the metering device, e.g., as with a film press. During application of the coating and metering, the paper web (or other substrate) may be supported in many ways, such by a backing roll, e.g., via one or two applicators, or without an underlying support, i.e., by the tension of the web or substrate alone.

The time the coating is in contact with the paper before the excess is finally removed is known as the dwell time. The dwell time may be short, long, or variable. The dwell time may change depending on the coating composition and the substrate.

The coating is usually added to the substrate by a coating head at a coating station. According to the quality desired, paper may be uncoated, single-coated, double-coated, or even triple-coated. When providing more than one coat, the initial coat (precoat) may have a different, less expensive, formulation and may contain a coarser pigment in the subsequent coating composition(s). A coater that is applying a coating on each side of the paper may have two or four coating heads, depending on the number of coating layers applied on each side of the paper (or other substrate). Most coating heads coat only one side at a time, but some roll coaters (e.g., film presses, gate rolls, and size presses) coat both sides in one pass.

Examples of known coaters which may be used in applying a coating composition include, without limitation, air knife coaters, blade coaters, rod coaters, bar coaters, multi-head coaters, roll coaters, roll or blade coaters, cast coaters, laboratory coaters, gravure coaters, kisscoaters, liquid application systems, reverse roll coaters, curtain coaters, spray coaters, and extrusion coaters.

Water may optionally be added to the solids comprising the coating composition to provide a concentration of solids such that, when the composition is coated onto a sheet at a desired target coating weight, the composition has a rheology that is suitable to enable the composition to be coated with a pressure (e.g., a blade pressure) of between 1 and 1.5 bar.

Calendering is a well known process in which paper smoothness and gloss is improved and bulk is reduced by passing a coated paper sheet between calender nips or rollers one or more times. According to some embodiments, the coated substrate, e.g., paper or paperboard, may be passed through the nips or rollers up to about 12 times. Usually, elastomer-coated rolls are employed for pressing high solids compositions. An elevated temperature may also be applied during calendering.

### Example

The Example discussed below is an exemplary embodiment of a coarse composition that includes a ground calcium carbonate having a relatively large median particle size and a relatively high steepness factor. This Example is the result of grinding and classifying calcium carbonate by the exemplary methods disclosed herein.

To make the exemplary ground calcium carbonate composition described of this Example, a marble ore was dry-milled in a Raymond mill to about 10-20 μm average diameter. The marble ore included greater than 90% by weight of calcite, less than 10% by weight of dolomite, less than 2% by weight of quartz, less than 2% by weight of chlorite, less than 2% by weight of mica, and less than 1% by weight of pyrite. The dry-milled product was then made into a slip containing about 35% solids without dispersant and using a dispersant-free process water. The ground calcium carbonate slip was then floated to remove impurities, although this exemplary floating step is optional. The floated product was then ground, without a dispersant, by wet milling through a stirred media mill (SMD). A dispersant may optionally be added to the wet-milling step.

According to the exemplary method, the wet-milled product was then passed through solid bowl decanter centrifuge in a first classification, which removed about 35% of the particles with a diameter less than 2 μm. It is contemplated that the first classification could be performed by other methods, such as the use of a hydrocyclone, hydraulic classifier, or elutriator. The coarse underflow was then passed back to the grinder feed. The fine particles from the centrifuge were dewatered in a bowl thickener to separate the water from the mineral and to raise the solid content of the composition. A small amount of flocculant or coagulant (about 15 ppm) was added to the thickener feed. The addition of flocculant or coagulant is optional. The composition was then passed twice through a hydrocyclone to remove additional fine particles in a second and third classification, and then the composition was thickened. It is contemplated that the second and third classifications could be performed by other methods, such as the use of a centrifuge, hydraulic classifier, or elutriator. The thickened product was then sent to a rotary vacuum filter. A filter cake was produced and screened at a 325 mesh. According to some embodiments, the dispersant may not be added until after the rotary vacuum filtration step.

The sample prepared was abrasion tested using the Einlehner abrasion method. A slurry containing 15% solids was abraded in an Einlehner abrader at the setting of 174,000 revolutions (174 krev). The results of the abrasion test are shown in Table II below.

It is contemplated that, according to some embodiments, the calcium carbonate may be ground before classification, as described above.

Table II, below, lists the particle size distribution; 30%, 50%, and 70% psd values; steepness factor; and BET surface area for the calcium carbonate component of one exemplary embodiment of the compositions.

TABLE II

| Sedigraph 5100 | Composition | |
|---|---|---|
| <10 μm (%) | 98 | wt. % |
| <5 μm (%) | 81 | wt. % |
| <2 μm (%) | 40 | wt. % |
| <1 μm (%) | 13 | wt. % |
| <0.5 μm (%) | 2 | wt. % |
| <0.25 μm (%) | 1 | wt. % |
| d₃₀ | 1.7 | μm |
| d₅₀ | 2.6 | μm |
| d₇₀ | 4.0 | μm |
| Steepness Factor | 43 | |
| BET Surface Area | 3 | m²/g |

| | |
|---|---|
| Einlehner Abrasion | 6.2 mg/loss @ 100 krev |

It can be seen from Table II that the median particle size (d₅₀) of the composition is relatively large, about 2.6 μm. However, even though the median particle size may be similar to other compositions, the overall particle size distribution of the ground calcium carbonate differs in that the calcium carbonate may have a relatively high steepness factor of at least about 30, for example, about 43. The exemplary triple classification process also removes the coarsest particles, resulting in a greater percentage of particles having an esd less than about 10 μm, while still maintaining a generally coarse particle size distribution. The overall coarse particle size distribution is also indicated by the relatively low percentage of fine particles (e.g., particles with an esd less than 1 μm).

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising ground calcium carbonate having a d₅₀ of at least about 2.4 μm and a steepness factor of at least about 30.

2. The composition according to claim 1, wherein the ground calcium carbonate has a d₅₀ of at least about 2.6 μm.

3. The composition according to claim 1, wherein the ground calcium carbonate has a d₅₀ of at least about 2.8 μm.

4. The composition according to claim 1, wherein greater than or equal to about 96 percent of the ground calcium carbonate has an esd less than about 10 μm.

5. The composition according to claim 1, wherein the ground calcium carbonate has a steepness factor of at least about 32.

6. The composition according to claim 1, wherein the ground calcium carbonate has a steepness factor of at least about 34.

7. The composition according to claim 1, wherein the ground calcium carbonate has a steepness factor of at least about 36.

8. The composition according to claim 1, wherein the ground calcium carbonate has a steepness factor of at least about 40.

9. The composition according to claim 1, wherein the ground calcium carbonate has a steepness factor of at least about 43.

10. The composition according to claim 1, further comprising an additive.

11. The composition according to claim 10, wherein the additive is kaolin.

12. The composition according to claim 11, wherein the kaolin has a shape factor greater than about 40.

13. The composition according to claim 1, wherein the composition is substantially free of additives.

14. A coating comprising:
a ground calcium carbonate having a d₅₀ of at least about 2.4 μm and a steepness factor of at least about 30; and
a carrier suspending the ground calcium carbonate, wherein the ground calcium carbonate is substantially non-aggregated in the carrier.

15. The coating according to claim 14, wherein the ground calcium carbonate has a d₅₀ of at least about 2.6 μm.

16. The coating according to claim 14, wherein the ground calcium carbonate has a d₅₀ of at least about 2.8 μm.

17. The coating according to claim 14, wherein greater than or equal to about 96 percent of the ground calcium carbonate has an esd less than about 10 μm.

18. The coating according to claim 14, wherein the ground calcium carbonate has a steepness factor of at least about 32.

19. The coating according to claim 14, wherein the ground calcium carbonate has a steepness factor of at least about 34.

20. The coating according to claim 14, wherein the ground calcium carbonate has a steepness factor of at least about 36.

21. The coating according to claim 14, wherein the ground calcium carbonate has a steepness factor of at least about 40.

22. The coating according to claim 14, wherein the ground calcium carbonate has a steepness factor of at least about 43.

23. The coating according to claim 14, further comprising an additive.

24. The coating according to claim 23, wherein the additive is kaolin.

25. The coating according to claim 24, wherein the kaolin has a shape factor greater than about 40.

26. The coating according to claim 14, wherein the carrier comprises an organic solvent.

27. The coating according to claim 14, wherein the carrier comprises an inorganic solvent.

28. The coating according to claim 14, wherein the carrier comprises a polymer.

29. The coating according to claim 14, wherein the carrier is water.

30. A product comprising:
a substrate; and
a coating applied to the substrate, wherein the coating comprises a ground calcium carbonate having a d₅₀ of at least about 2.4 μm and a steepness factor of at least about 30.

31. The product according to claim 30, wherein the ground calcium carbonate has a d₅₀ of at least about 2.6 μm.

32. The product according to claim 30, wherein the ground calcium carbonate has a d₅₀ of at least about 2.8 μm.

33. The product according to claim 30, wherein greater than or equal to about 96 percent of the ground calcium carbonate has an esd less than about 10 μm.

34. The product according to claim 30, wherein the ground calcium carbonate has a steepness factor of at least about 32.

35. The product according to claim 30, wherein the ground calcium carbonate has a steepness factor of at least about 34.

36. The product according to claim 30, wherein the ground calcium carbonate has a steepness factor of at least about 36.

37. The product according to claim 30, wherein the ground calcium carbonate has a steepness factor of at least about 40.

38. The product according to claim 30, wherein the ground calcium carbonate has a steepness factor of at least about 43.

39. The product according to claim 30, wherein the substrate is paperboard.

40. The product according to claim 30, wherein the substrate is paper.
